(19) United States
(12) Patent Application Publication
(10) Pub. No.: US 2024/0174231 A1
(43) Pub. Date: May 30, 2024

(54) METHOD FOR ADJUSTING AN AUTOMATIC SPEED CONTROL OF A VEHICLE

(71) Applicant: Robert Bosch GmbH, Stuttgart, DE (US)

(72) Inventor: Alexander Boronka, Loechgau (DE)

(21) Appl. No.: 18/506,691

(22) Filed: Nov. 10, 2023

(30) Foreign Application Priority Data
Nov. 28, 2022 (DE) 10 2022 212 711.0

(51) Int. Cl. B60W 30/14

(52) U.S. Cl. CPC B60W 30/146; B60W 2520/06; B60W 2540/12; B60W 2540/215; B60W 2552/15; B60W 2552/30; B60W 2552/53; B60W 2555/20; B60W 2555/60; B60W 2556/10; B60W 2556/40; B60W 2720/10

(57) ABSTRACT

A method for adjusting an automatic speed control of a vehicle. The method includes: receiving environment sensor data of at least one environment sensor of the vehicle and/or map data of a map representation representing the environment of the vehicle; on the basis of the environment sensor data and/or the map data, determining a speed limit for a roadway being driven by the vehicle; by means of the automatic speed control, adjusting the vehicle speed to a speed value corresponding to the speed limit; on the basis of the environment sensor data and/or on the basis of the map data, identifying a marked stretch of roadway of a roadway being driven by the vehicle; and adjusting the vehicle speed regulated by the automatic speed control to a predefined vehicle speed stored in speed information for driving over the marked stretch of roadway.

### CROSS REFERENCE

The present application claims the benefit under 35 U.S.C. § 119 of German Patent Application No. DE 10 2022 212 711.0 filed on Nov. 28, 2022, which is expressly incorporated herein by reference in its entirety.

### FIELD

The present invention relates to a method for adjusting an automatic speed control of a vehicle.

### BACKGROUND INFORMATION

Automatic speed controllers for vehicles of a wide variety of designs are described in the related art.

It is an object of the present invention to provide an improved method for adjusting an automatic speed control of a vehicle.

### SUMMARY

The object may be achieved by the method for adjusting an automatic speed control of a vehicle according to features of the present invention. Advantageous embodiments of the present invention are disclosed herein.

According to one aspect of the present invention, a method for adjusting an automatic speed control of a vehicle is provided. According to an example embodiment of the present invention, the method comprises:
receiving environment sensor data of at least one environment sensor of the vehicle and/or map data of a map representation representing the surroundings of the vehicle;
on the basis of the environment sensor data and/or the map data, determining a speed limit for a roadway being driven by the vehicle;
by means of the automatic speed control, adjusting the vehicle speed to a speed value corresponding to the speed limit; on the basis of the environment sensor data and/or on the basis of the map data, identifying a marked stretch of roadway of a roadway being driven by the vehicle; and
adjusting the vehicle speed regulated by the automatic speed control to a predefined vehicle speed stored in speed information for driving over the marked stretch of roadway.

A technical advantage can thereby be achieved that an improved method for adjusting an automatic speed control of a vehicle can be provided. According to an example embodiment of the present invention, for this purpose, when a marked stretch of roadway is identified, the vehicle speed regulated by the automatic speed control is adjusted to match a prioritized speed value pre-stored for the corresponding marked stretch of roadway. In this way, it can be achieved that, for marked stretches of roadway of a roadway being driven by the corresponding vehicle, the vehicle speed can be downwardly regulated from the setpoint speed regulated by the automatic speed control to a speed that can be adjusted individually to the respective driver. Depending on the stretch of roadway, the vehicle speed can thus be automatically downwardly regulated to the speed prioritized by the respective driver. In deviation from the permitted maximum speed in marked stretches of roadway of the roadway being driven, the automatic speed control can thus be adjusted to speed values that are individually matched to and pre-stored for the corresponding stretches of roadway. The automatic speed control can thus be matched to the respectively desired driving behavior of the vehicle in the corresponding marked stretches of roadway. This increases driving comfort and the safety of the vehicle.

Within the meaning of the application, an automatic speed control for a vehicle is designed as a cruise control or a speed control system.

According to one example embodiment of the present invention, the marked stretch of roadway of the roadway comprises a curve, an uphill gradient, a downhill gradient, a tunnel entrance, a tunnel exit, a bridge underpass, a school area, a constriction of the roadway, a construction site area, an insufficiently illuminated area.

As a result, a technical advantage can be achieved that, if necessary, stretches of roadway that are dangerous or subjectively perceived as dangerous in which the risk of an accident is increased, the setpoint speed of the automatic speed control can be adjusted to the respective individual properties of the stretch of roadway in question. This in turn increases driving comfort or the safety of the vehicle. As an alternative or in addition to the areas listed above, further stretches of a roadway can be taken into account.

According to one example embodiment of the present invention, the pre-stored speed information comprises a speed value and/or a percentage speed change value, wherein the speed value corresponds to a speed to which the vehicle speed regulated by the automatic speed control has been adjusted by an active intervention by a driver of the vehicle during a temporally preceding driving over the corresponding marked stretch of roadway, wherein the percentage speed change value corresponds to a change in speed, in order to adjust the vehicle speed regulated by the automatic speed control through the active intervention of the driver of the vehicle during the temporally preceding driving over the corresponding marked stretch of roadway, and wherein, in adjusting the speed, the vehicle speed is adjusted to the speed value and/or by the speed adjustment value in the speed information.

As a result, a technical advantage can be achieved that an individual adjustment of the automatic speed control to a driving behavior preferred by the corresponding driver of the vehicle is enabled. For this purpose, active interventions by the driver, which were executed by the driver in temporally preceding journeys in the corresponding marked stretches of roadway, are recorded and stored in the automatic speed control. The corresponding speed values or speed change values to which or by which the driver has reduced the vehicle speed during active intervention in the automatic speed control are recorded and stored as speed information. When driving over the corresponding marked stretch of roadway again, the automatic speed control can thus be automatically reduced from the automatically set setpoint speed to the speed value respectively stored in the speed information or by the speed change values stored in the speed information. The vehicle can thus automatically be braked to the speed to which the driver reduced the speed when previously driving the marked stretch of roadway. By the downward regulation of the setpoint vehicle speed automatically set by the automatic speed control when driving over the marked stretches of roadway, it can be achieved that a subjective perception of the driver when driving over the marked stretches of roadway can be improved. The automatic speed control usually regulates the vehicle speed to the permitted maximum speed or to a previously set setpoint speed value below the permitted maximum speed. When driving over some stretches of roadway, for example a curve section or an entry or exit of a tunnel, the set setpoint speed can however appear subjectively too high to the driver. By downwardly regulating the speed set by the automatic speed control to the speed to which the driver has braked the speed during previous driving over the marked stretch of roadway, the speed for driving over the marked stretch of roadway can thus be set automatically to one which is subjectively regarded by the driver as a suitable speed. For example, when driving over stretches of roadway in the vicinity of schools or preschools, the permitted maximum speed can seem too high to the driver, for which reason the driver would prefer a maximum speed lower than the permitted maximum speed. The same applies to curve sections in which the permitted maximum speed can also appear subjectively to the driver as too high. By downwardly regulating the speed of the automatic speed control, the driving behavior of the driver or his subjective perception regarding the driving behavior of the vehicle can thus be improved. Since the speed of the automatic speed control is reduced to the speed to which the driver has braked the vehicle during previous driving over of the marked stretch of roadway, the automatic speed control can automatically be adjusted to the preferred speed for driving over the marked stretch of roadway. This enables an individual adjustment of the automatic speed control to the preferred driving behavior of the driver of the vehicle. Alternatively, the speed can also be increased if the driving behavior of the driver prefers a speed higher than the regulated speed.

According to one example embodiment of the present invention, the speed information was detected and stored during at least one journey of the vehicle made earlier in time.

A technical advantage can thereby be achieved that an individual adjustment of the automatic speed control to the preferred driving behavior of the driver is made possible. As a result of the automatic recording of speed information during earlier journeys of the vehicle in the form of speed change values to which the driver has braked the vehicle during active intervention in the automatic speed control, a complex adjustment process of the automatic speed control is not necessary.

According to one example embodiment of the present invention, the active intervention in the automatic speed control by the driver comprises: operating a brake of the vehicle, reducing a setpoint speed of the automatic speed control, switching off the automatic speed control.

A technical advantage can thereby be achieved that different actions with which the driver can actively intervene in the automatic speed control for braking the vehicle or for reducing the vehicle speed can be taken into account.

According to one example embodiment of the present invention, the speed information further comprises position information of the marked location on the roadway and a direction of travel of the vehicle, wherein the identification of the marked stretch of roadway comprises:

Comparing the position information in the speed information with vehicle position information based on the map data and/or information of a navigation system.

A technical advantage can thereby be achieved that a simple identification of the stretch of roadway is made possible. In this case, the speed information comprises position information regarding the marked stretches of roadway in which the speed information was recorded when driving over the corresponding stretches of roadway, that is to say, in which said information was recorded or stored when the driver actively intervened in the automatic speed control during previous driving. In order to identify the corresponding marked stretch of roadway, only a comparison of the position information in the speed information with the position information of the vehicle is required. The position information of the vehicle can be provided, for example, via position information in the map representation or position information of a navigation system, for example of a global navigation satellite system. If the current position of the vehicle, which is given by the position information in the map representation or the navigation system, matches the position information in the respective speed information, the corresponding marked stretch of roadway will be identified. In addition, the speed information can also comprise a direction of travel of the vehicle in addition to the position information. The direction of travel can be compared with a direction of travel designated for the respective roadway being driven.

According to one example embodiment of the present invention, the speed information further comprises weather information regarding weather conditions which were prevailing in the environment of the vehicle at time when the driver actively intervened in the automatic speed control, and wherein the speed is adjusted if comparable weather conditions are present.

A technical advantage can thereby be achieved that a further improvement in the precision of speed adjustment by the automatic speed control is made possible. By taking into account weather conditions which were present when driving over the marked stretch of roadway at the time when speed information was generated or stored in the automatic speed control as a result of the active intervention of the driver, the respective weather conditions can be taken into account when the marked stretch of roadway is driven again and when the speed of the automatic speed control is correspondingly adjusted taking into account the speed information. In particular for cases in which similar or comparable weather conditions are present, the corresponding adjustment of the speed can be made. If, for example, during the original driving of the marked stretch of roadway during which the speed information was recorded, poor weather conditions were present, for example slipperiness or poor visibility, for example during night hours, then when the marked stretch of roadway is driven again, for example under conditions of good visibility, the reduction in the speed of the automatic speed control can be dispensed with. By taking into account the weather conditions, a precise adjustment of the speed of the automatic speed control to the driving behavior that is preferred by the driver can thus be achieved.

According to one example embodiment of the present invention, the speed information comprises information regarding snowfall, precipitation, visibility, light conditions, black ice, roadway wetness, wind from the side, from the front or from behind.

A technical advantage can thereby be achieved that meaningful weather information is taken into account. In particular, weather conditions which reduce the safety of the vehicle and thus cause the driver to subjectively consider the vehicle speed to be too high can be taken into account.

According to one example embodiment of the present invention, the speed information will only be saved if the active intervention in the automatic speed control by the driver was not caused by a traffic situation prevailing at the time of active intervention by the driver.

As a result, a technical advantage can be achieved that exclusively meaningful speed information which is primarily related to the corresponding properties of the marked stretch of roadway being driven is stored. In cases in which the active intervention in the automatic speed control by the driver was not primarily motivated by the respective properties of the stretch of roadway being driven but by the respectively present traffic situation, saving the speed information can be dispensed with. If the driver intervenes in the automatic speed control, for example, because the vehicle is approaching the tail of a traffic jam, but the stretch of roadway being driven in each case does not contribute to the driving speed being subjectively perceived by the driver as too high, then the active intervention in the automatic speed control can be ignored during provision of corresponding speed information. When driving over the corresponding marked stretch of roadway again, an approach to the tail of a traffic jam should not be assumed, so that an automatic reduction in the setpoint speed regulated by the automatic speed control can be dispensed with.

According to one example embodiment of the present invention, the speed information is stored as partial information in a driver profile, wherein the driver profile comprises a plurality of items of speed information for a plurality of marked stretches of roadway of a plurality of roadways, wherein the speed information in the driver profile is based on active interventions in the automatic speed control by the driver during earlier journeys.

As a result, a technical advantage can be achieved that a precise adjustment of the automatic speed control to the driving behavior preferred by the respective driver of the vehicle is made possible. For this purpose, a plurality of items of speed information for a plurality of marked stretches of roadway is stored in the form of a driver profile of the respective driver of the vehicle. On the basis of the driver profile created in this way, the automatic speed control can be adjusted to the driver's preferred speeds for many different stretches of roadway being driven by the vehicle. This increases the subjectively perceived driving behavior of the vehicle.

According to one example embodiment of the present invention, the identification of the marked stretch of roadway comprises: classifying the different marked stretches of roadway in the driver profile; and identifying from the map data a stretch of roadway that can be assigned to a class of stretches of roadway in the driver profile.

As a result, a technical advantage can be achieved that an adjustment of the speed of the automatic speed control can also be carried out for stretches of roadway, for which no speed information has previously been recorded and which have not previously been driven by the driver. The driver profile comprises a plurality of items of speed information which were recorded for driving over a plurality of stretches of roadway.

Since the stretches of roadway in the driver profile are classified into corresponding section classes, for example into curve sections or entries or exits of tunnel sections, corresponding stretches of roadway can be identified in the map representation and the speed information stored in the driver profile for the corresponding section classes can be applied accordingly to the stretches of roadway identified in the map representation. If an average speed reduction by intervention in the automatic speed control by the driver is recorded in the driver profile for tunnel entrances, a speed reduction can thus also be automatically carried out in accordance with the speed information in the driver profile when a tunnel section never previously driven is driven. This enables a greater precision of the automatic speed control and adjustment to the respectively preferred driving behavior of the driver of the vehicle.

According to one example embodiment of the present invention, the classification and the identification are performed by a correspondingly trained artificial intelligence.

A technical advantage can thereby be achieved that the correspondingly trained artificial intelligence enables a precise classification of the individual stretches of roadway in the driver profile and a correspondingly precise identification of stretches of roadway in the map data that can be assigned to the corresponding section classes of the classified marked stretches of roadway in the driver profile. This enables the precise identification of the marked stretches of roadway and associated therewith a precise adjustment of the automatic speed control to the preferred driving behavior of the driver.

According to one example embodiment of the present invention, the method further comprises:
displaying the adjustment to be made of the speed regulated by the automatic speed control, and
maintaining the speed regulated by the automatic speed control if the driver does not agree with the adjustment.

A technical advantage can thereby be achieved that the driver can be informed of the impending downward regulation of the vehicle speed automatically regulated by the automatic speed control. In this case, the driver can decide whether a corresponding reduction in the speed is desired or whether the respective stretch of roadway being driven is to be driven at the setpoint speed of the automatic speed control. This further increases the subjectively perceived driving behavior of the vehicle.

According to a further aspect of the present invention, a computing unit is provided, which is configured to carry out the method according to the present invention for adjusting an automatic speed control of a vehicle according to any one of the above-described embodiments.

According to a further aspect of the present invention, a computer program product is provided, comprising commands that, when the program is executed by a data processing unit, cause the data processing unit to execute the method according to the present invention for adjusting an automatic speed control of a vehicle according to any one of the above-described embodiments.

Exemplary embodiments of the present invention are explained with reference to the figures.

### BRIEF DESCRIPTION OF THE DRAWINGS

FIG. 1 shows a schematic representation of a system for the adjustment of an automatic speed control of a vehicle, according to an example embodiment of the present invention.

FIG. 2 shows a flow chart of a method for the adjustment of an automatic speed control of a vehicle, according to an example embodiment of the present invention.

FIG. 3 shows a schematic representation of a computer program product, according to an example embodiment of the present invention.

### DETAILED DESCRIPTION OF EXAMPLE EMBODIMENTS

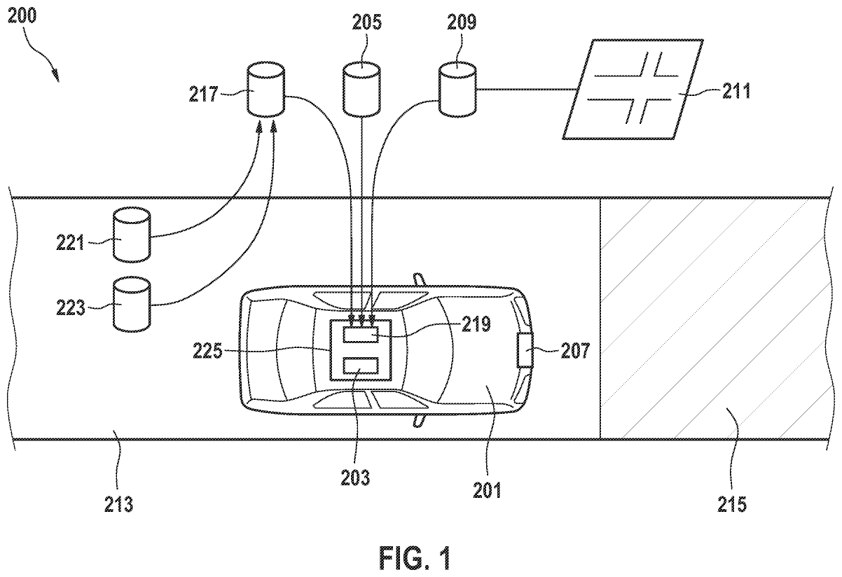

FIG. 1 shows a schematic representation of a system 200 for adjusting an automatic speed control 203 of a vehicle 201.

FIG. 1 shows a vehicle 201 driving on a roadway 213. The vehicle 201 comprises a computing unit 225 which is configured to carry out the method 100 according to the present invention for the adjustment of an automatic speed control 203. A corresponding automatic speed control 203 is formed in the computing unit 225. The automatic speed control 203 can, for example, take the form of a commercially available cruise control. In addition, an adjustment module 219 for adjusting the speed of the automatic speed control 203 is configured in the computing unit 225.

The vehicle 201 further comprises at least one environment sensor 207 by means of which an environment of the vehicle 201 can be perceived. The environment sensor 207 can be designed, for example, as a camera sensor, lidar sensor, radar sensor or another commercially available environment sensor.

To carry out the adjustment of the speed control 203, the computing unit 225 first receives environment sensor data 205 from the at least one environment sensor 207 and/or map data 209 from a map representation 211 representing the environment of the vehicle 201. The map representation 211 can, for example, take the form of a digital road map in which, among other things, the roadway 213 being driven is shown.

On the basis of the environment sensor data 205 and/or the map data 209, a speed limit for driving over the roadway 213 is determined by the computing unit 225 or by the automatic speed control 203. The speed limit can be visible, for example, via corresponding road signs at the roadway edge or via corresponding information within the map representation 211. Taking into account the speed limit which defines a maximum permitted maximum speed, the automatic speed control 203 regulates the corresponding vehicle speed 201. In this case, the speed is adjusted to a corresponding setpoint speed which corresponds to the speed limit.

According to the present invention, following this a marked stretch of roadway 215 of the roadway 213 to be driven by the vehicle 201 is identified. The marked stretch of roadway 215 can be given, for example, by a curve section, an entry area or exit area of a tunnel or by a corresponding uphill gradient or a downhill gradient of the roadway 213 or, for example, by an area in the vicinity of a school or a preschool.

According to the present invention, following this the setpoint speed set by the automatic speed control 203 is then reduced for driving over the identified marked stretch of roadway 215. This takes place taking into account speed information 217 stored in the computing unit 225. The speed information 217 defines a predefined speed for driving over the marked stretch of roadway 215.

Taking into account the speed information 217 for driving over the marked stretch of roadway 215, the adjustment module 219 thus downwardly regulates the setpoint speed of the automatic speed control 203.

According to one embodiment, the speed information 217 is based on an active intervention in the automatic speed control 203 by a driver of the vehicle 201 during a temporally preceding driving over the roadway 213 or of the marked stretch of roadway 215.

The present invention is based on the idea that the automatic speed control 203 in marked stretches of roadway 215 is downwardly regulated to speeds which correspond to a preferred driving behavior of the driver of the vehicle 201. For this purpose, the speed information 217, on the basis of which the setpoint speed of the automatic speed control 203 is downwardly regulated when driving over the marked stretch of roadway 215, can be based on speeds which, in the case of a temporally preceding driving over the marked stretch of roadway 215 by the vehicle 201, have been defined by an active intervention in the automatic speed control 203 by the driver, for example by operating the brake of the vehicle 201, by downwardly regulating the setpoint speed of the automatic speed control 203 or by switching off the automatic speed control 203.

According to one embodiment, when the vehicle 201 is traveling, every time the driver of the vehicle 201 intervenes in the automatic speed control 203 and the setpoint speed of the automatic speed control 203 is reduced thereby, these active interventions are recorded and stored in the form of speed information 217. These items of speed information 217 describe the speed values and/or the speed change values to which or by which the speeds of the automatic speed control 203 have been reduced by the intervention of the driver.

The speed information 217 can further comprise position information 221. The position information 221 here describes the positions of the vehicle 201 which the vehicle 201 occupied during active intervention in the automatic speed control 203 by the driver. Via the position information 221, the corresponding positions of the marked stretches of roadway 215 in which the active intervention in the automatic speed control 203 by the driver was recorded can thus be defined.

According to one embodiment, speed information 217 for a plurality of different marked stretches of roadway 215 being driven by the vehicle 201 can be recorded and stored in the form of a driver profile. In the form of the plurality of speed information items 217 for the plurality of different marked stretches of roadway 215, the driver profile describes the driving behavior of the vehicle 201 preferred by the driver in the corresponding marked stretches of roadway 215.

When driving over the respective stretches of roadway 215 by the vehicle 201, the adjustment module 219 can thus read in the speed information 217 stored correspondingly for the respective marked stretch of roadway 215, and the speed of the automatic speed control 203 can be adjusted to the speed value or adjusted taking into account the speed change value in the speed information 217.

According to one embodiment, the plurality of speed information items 217 for the different marked stretches of roadway 215 can be based on a plurality of journeys of the vehicle 201 over the respective marked stretches of roadway 215, in that the active interventions in the automatic speed control 203 by the driver carried out in each case to reduce the speed and the corresponding speed reductions are recorded in the corresponding speed information 217.

According to one embodiment, in order to identify the marked stretch of roadway 215 being driven in each case by the vehicle 201, the position information 221 in the speed information 217 stored in the driver profile can thus be compared with position information of the vehicle 201. The position information of the vehicle 201 can, for example, be based on the map representation 211 or on information of a navigation system. If the position information of the vehicle 201, which describes the current of the vehicle 201, matches the position information 221 of an item of speed information 217 stored in the driver profile, the corresponding marked stretch of roadway 215 will be identified.

Alternatively, corresponding stretches of roadway 215 can be identified by a correspondingly trained object recognition function based on the environment sensor data 205.

Alternatively, identification of the marked stretches of roadway 215 can be carried out by a correspondingly trained artificial intelligence. This can be trained to classify into corresponding section classes the marked stretches of roadway 215 stored in the driver profile, for which the corresponding speed information 217 is secured. The stretches of roadway 215 can be classified, for example, into curve sections, entry areas into tunnels, exit areas in tunnels or areas in the vicinity of a school or a preschool. The correspondingly trained artificial intelligence can furthermore be trained to identify from the map representation 211 corresponding stretches of roadway 215 which can be assigned to the corresponding section classes. When driving over the corresponding areas by the vehicle 201, an identification of a driven stretch of roadway as a correspondingly marked stretch of roadway 215 can thus be made.

According to one embodiment, the speed information 217 further comprises weather information 223. In this case, the weather information 223 describes weather conditions which were present at the time when the speed information 217 was recorded by the active intervention in the automatic speed control 203 by the driver. The weather information 223 can be taken into account for adjusting the automatic speed control 203 when driving over the different marked stretches of roadway 215. The automatic speed control 203 can be adjusted exclusively if, when the marked stretch of roadway 215 stored in the driver profile is driven again, the same or similar weather conditions are present, as was the case when the stretch of roadway 215 was driven at the time of recording the speed information 217.

According to one embodiment, the recorded speed information 217 is stored exclusively in the driver profile when the speed reduction resulting from the active intervention in the automatic speed control 203 by the driver is based exclusively on the properties of the particular marked stretch of roadway 215 being driven. If the speed reduction or the active intervention in the automatic speed control 203 by the driver takes place due to correspondingly prevailing traffic conditions, because the vehicle 201, for example, is approaching the tail of a traffic jam, the corresponding speed information which is registered due to the driver's intervention in the automatic speed control 203 will not be stored in the driver profile, since the active intervention of the driver is not primarily attributable to the properties of the stretch of roadway traveled but rather to the volume of traffic present.

According to the present invention, while the vehicle 201 is being driven along different roadways 213 with corresponding stretches of roadway 215, when the driver intervenes in the automatic speed control 203 corresponding speed information 217 will be registered and stored in a driver profile. Corresponding speed information 217 is thus stored in the corresponding driver profile for different marked stretches of roadway 215. The speed information 217 here describes the respective speed value to which the vehicle speed 201 was reduced by the active intervention of the driver or a corresponding speed change value, in order to reduce the vehicle speed 201 by the active intervention of the driver.

The active intervention in the automatic speed control 203 by the driver during driving of the vehicle 201 is here the triggering event for storing the corresponding speed information 217 in the driver profile. As a result of the active intervention, the respectively driven stretch of roadway 215 is also characterized in the driver profile as a correspondingly marked stretch of roadway 215.

When driving over the stretch of roadway 213 which is characterized correspondingly as a marked stretch of roadway 215, by retrieving the speed information 217 stored correspondingly in the driver profile for the respective marked stretch of roadway 215, the setpoint speed of the automatic speed control 203 can thus be automatically downwardly regulated to the speed in the speed information 217.

An individual adjustment of the automatic speed control can thus be brought about via the driver profile and the speed information 217 being matched individually to the driving behavior of the driver for the different roadways 213 and the corresponding stretches of roadway 215. When driving over a stretch of a roadway 213 characterized as a correspondingly marked stretch of roadway 215, the speed control 203 can thus be automatically downwardly regulated to the respective individually preferred speed matched to the driving behavior of the driver in the speed information 217 stored correspondingly in the driver profile.

According to one embodiment, the desired downward regulation of the speed can be displayed to the driver before the speed of the automatic speed control 203 is downwardly regulated. The driver can then decide whether the speed of the automatic speed control 203 is to be maintained or the speed is to be reduced to the speed stored in the corresponding speed information 217.

The corresponding driver profile is thus based on a plurality of speed information items recorded at earlier points in time, which are based on active interventions in the automatic speed control 203 by the driver.

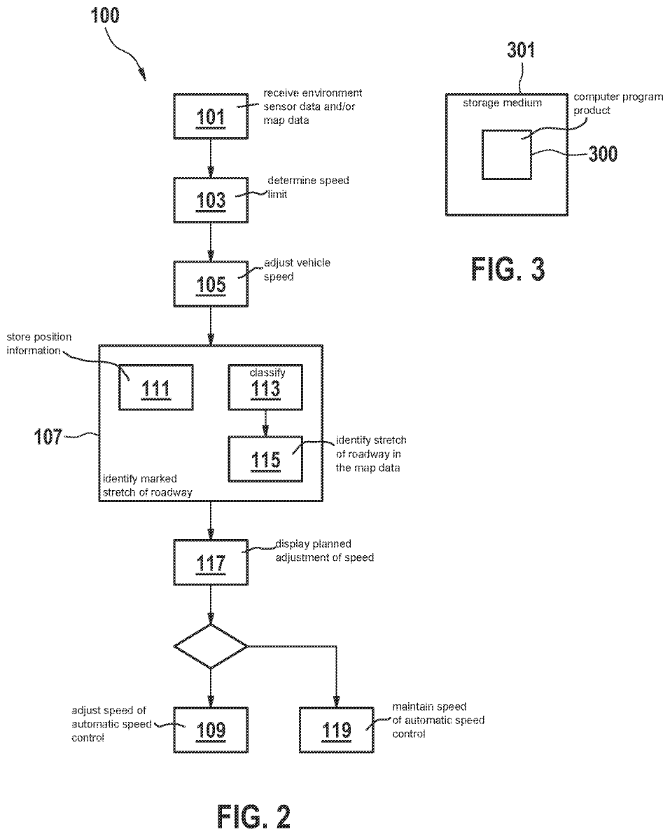

FIG. 2 shows a flow chart of a method 100 for adjusting an automatic speed control 203 of a vehicle 201.

According to the present invention, in a first method step 101, firstly environment sensor data 205 of at least one environment sensor 207 and/or map data 209 of at least one map representation 211 are received.

In a further method step 103, a speed limit for the roadway 213 being driven by the vehicle 201 is determined on the basis of the environment sensor data 205 and/or the map data 209.

In a further method step 105, the automatic speed control 203 adjusts the vehicle speed 201 to a speed value corresponding to the speed limit.

In a further method step 107, a marked stretch of roadway 215 being driven by the vehicle 201 is identified on the basis of the environment sensor data 205 and/or on the basis of the map data 209.

For this purpose, in a further method step 111, position information 221 in speed information 217 stored in a driver profile, which is stored for the respective stretch of roadway 215, is compared with position information of the vehicle 201 which describes a current position of the vehicle 201. If the position information 221 in the speed information 217 of the driver profile matches the current position of the vehicle 201, the stretch of roadway 215 currently being driven by the vehicle 201 will be identified as the marked stretch of roadway 215, for which the speed information 217 respectively read in is stored in the driver profile.

Alternatively, in a further method step 113, the different marked stretches of roadway 215 in the driver profile are classified in order to identify the marked stretch of roadway 215 and are classified into corresponding section classes.

In a further method step 115, a stretch of roadway in the map data 209 of the map representation 211 is identified by assignment of the section classes of the stretches of roadway 215 in the driver profile as a corresponding marked stretch of roadway 215 according to the stretches of roadway in the driver profile.

In a further method step 117, the driver is displayed a planned adjustment of the speed of the automatic speed control 203 according to the speed information 217 stored in the driver profile for the respectively identified marked stretch of roadway 215.

If the driver decides against a speed change in the speed of the automatic speed control 203 according to the speed information 217 in the driver profile, the speed of the automatic speed control 203 will be maintained in a further method step 119.

If the driver decides in favor of the planned change in speed, in a further method step 109 the speed of the automatic speed control 203 will be adjusted to the speed in the speed information 217 stored in the driver profile for the identified marked stretch of roadway 215, and the speed reduced accordingly.

FIG. 3 shows a schematic representation of a computer program product 300, comprising commands that, when the program is executed by a data processing unit, cause this data processing unit to carry out the method 100 for the adjustment of an automatic speed control 203 of a vehicle 201.

In the embodiment shown, the computer program product 300 is stored on a storage medium 301. The storage medium 301 can be any storage medium available from the related art.

What is claimed is:

1. A method for adjusting an automatic speed control of a vehicle, comprising the following steps:
receiving environment sensor data of at least one environment sensor of the vehicle and/or map data of a map representation representing the environment of the vehicle;
based on the environment sensor data and/or the map data, determining a speed limit for a roadway being driven by the vehicle;
using the automatic cruise control, regulating a vehicle speed to a speed value corresponding to the speed limit;
based on the environment sensor data and/or based on the map data, identifying a marked stretch of roadway of the roadway being driven by the vehicle; and
adjusting the vehicle speed regulated by the automatic speed control to a predefined vehicle speed stored in speed information for driving over the marked stretch of roadway.

2. The method according to claim 1, wherein the marked stretch of roadway of the roadway includes a curve, or an uphill gradient, or a downhill gradient, or a tunnel entrance, or a tunnel exit, or a bridge underpass, or a school area.

3. The method according to claim 1, wherein the speed information includes a speed value and/or a percentage speed change value, wherein the speed value corresponds to a speed at which the vehicle speed regulated by the automatic speed control has been adjusted by an active intervention by a driver of the vehicle during a temporally preceding driving over the corresponding marked stretch of roadway, wherein the percentage speed change value corresponds to a change in speed, to adjust the vehicle speed regulated by the automatic speed control through the active intervention of a driver of the vehicle during the temporally preceding driving over the corresponding marked stretch of roadway, and wherein, in adjusting the speed, the vehicle speed is adjusted to the speed value and/or by the speed change value in the speed information.

4. The method according to claim 3, wherein the speed information was detected and stored during at least one journey of the vehicle made earlier in time.

5. The method according to claim 3, wherein the active intervention in the automatic speed control by the driver includes: operating a brake of the vehicle, or reducing a setpoint speed of the automatic speed control, or switching off the automatic speed control.

6. The method according to claim 1, wherein the speed information further includes position information of the marked stretch of roadway and/or a direction of travel of the vehicle, and wherein the identification of the marked stretch of roadway includes:
comparing the position information in the speed information with position information of the vehicle, based on the map data and/or information of a navigation system.

7. The method according to claim 1, wherein the speed information further includes weather information regarding weather conditions which were prevailing in an environment of the vehicle at a time when the driver actively intervened in the automatic speed control, and wherein the speed is adjusted when comparable weather conditions are present.

8. The method according to claim 7, wherein the weather information includes information regarding snowfall, or precipitation, or visibility, or light conditions, or black ice, or roadway wetness.

9. The method according to claim 3, wherein the speed information is stored only when the active intervention in the automatic speed control by the driver was not caused by a traffic situation prevailing at a time of active intervention by the driver.

10. The method according to claim 1, wherein the speed information is stored as partial information in a driver profile, wherein the driver profile includes a plurality of items of speed information for a plurality of marked stretches of roadway of a plurality of roadways, wherein the speed information in the driver profile is based on active interventions in the automatic speed control by the driver during earlier journeys.

11. The method according to claim 10, wherein the identification of the marked stretch of roadway includes:
classifying the plurality of marked stretches of roadway in the driver profile; and
identifying the stretch of roadway from the map data that can be assigned to a class of stretches of roadway in the driver profile.

12. The method according to claim 11, wherein the classification and the identification are performed by a correspondingly trained artificial intelligence.

13. The method according to claim 1, further comprising:
displaying the adjustment to be made of the speed regulated by the automatic speed control; and
maintaining the speed regulated by the automatic speed control when the driver does not agree with the adjustment.

14. A computing unit configured to adjust an automatic speed control of a vehicle, the computing unit configured to:
receive environment sensor data of at least one environment sensor of the vehicle and/or map data of a map representation representing the environment of the vehicle;
based on the environment sensor data and/or the map data, determine a speed limit for a roadway being driven by the vehicle;
using the automatic cruise control, regulate a vehicle speed to a speed value corresponding to the speed limit;
based on the environment sensor data and/or based on the map data, identify a marked stretch of roadway of the roadway being driven by the vehicle; and
adjust the vehicle speed regulated by the automatic speed control to a predefined vehicle speed stored in speed information for driving over the marked stretch of roadway.

15. A non-transitory computer-readable storage medium on which is stored a computer program including commands for adjusting an automatic speed control of a vehicle, the commands, when executed by a data processing unit, causing the data processing unit to perform the following steps:
receiving environment sensor data of at least one environment sensor of the vehicle and/or map data of a map representation representing the environment of the vehicle;
based on the environment sensor data and/or the map data, determining a speed limit for a roadway being driven by the vehicle;
using the automatic cruise control, regulating a vehicle speed to a speed value corresponding to the speed limit;
based on the environment sensor data and/or based on the map data, identifying a marked stretch of roadway of the roadway being driven by the vehicle; and
adjusting the vehicle speed regulated by the automatic speed control to a predefined vehicle speed stored in speed information for driving over the marked stretch of roadway.
